(19) United States
(12) Patent Application Publication
(10) Pub. No.: US 2023/0341684 A1
(43) Pub. Date: Oct. 26, 2023

(54) PHASE-COMPENSATED PUPIL-REPLICATING LIGHTGUIDE

(71) Applicant: Facebook Technologies, LLC, Menlo Park, CA (US)

(72) Inventors: Jilin Yang, Redmond, WA (US); Hee Yoon Lee, Kirkland, WA (US)

(21) Appl. No.: 17/727,658

(22) Filed: Apr. 22, 2022

(51) Int. Cl. G02B 27/01; G02B 6/293; G02B 6/35

(52) U.S. Cl. CPC G02B 27/0172; G02B 6/29316; G02B 6/3532

(57) ABSTRACT

A pupil-replicating lightguide includes an in-coupling grating structure, an out-coupling grating structure, and a phase compensation layer. The out-coupling grating structure has a spatially varying parameter such as grating duty cycle or grating thickness for evening out out-coupled distribution of light. The spatially varying out-coupling grating parameter disturbs the phase of the propagating image light. The phase compensation layer has a spatially varying optical thickness that compensates that disturbed phase to planarize an optical phase profile of out-coupled light, thereby improving a modulation transfer function of the pupil-replicating lightguide.

### TECHNICAL FIELD

The present disclosure relates to optical and imaging devices, and in particular to pupil-replicating lightguides usable in visual displays.

### BACKGROUND

Visual displays provide information to viewers including still images, video, data, etc. Visual displays have applications in diverse fields including entertainment, education, engineering, science, professional training, advertising, to name just a few examples. Some visual displays, such as TV sets, display images to several users, and some visual display systems, such s near-eye displays or NEDs, are intended to display images to individual users.

An artificial reality system may include an NED, e.g. a headset or a pair of glasses, configured to present content to a user, and optionally a separate console or a controller. The NED may display virtual objects or combine images of real objects with virtual objects in virtual reality (VR), augmented reality (AR), or mixed reality (MR) applications. For example, in an AR system, a user may view both images of virtual objects, e.g. computer-generated images or CGIs, and the surrounding environment by seeing through a “combiner” component. The combiner of a wearable display is typically transparent to external light but includes some light routing property to direct the display light into the user's field of view.

Because a display of HMD or NED is usually worn on the head of a user, a large, bulky, unbalanced, and/or heavy display apparatus with a heavy battery would be cumbersome and uncomfortable for the user to wear. Head-mounted display devices require compact and efficient illuminators that provide a uniform, even illumination of a display panel or other objects or elements in the display system. Compact planar optical components, such as lightguides, gratings, Fresnel lenses, etc., can be used to reduce size and weight of an optics block. However, compact planar optics may be prone to optical distortions and aberrations which need to be addressed for optimal performance of the display apparatus.

### BRIEF DESCRIPTION OF THE DRAWINGS

Exemplary embodiments will now be described in conjunction with the drawings, in which:

FIG. 1 is a side cross-sectional view of a phase-compensated pupil-replicating lightguide of this disclosure;

FIG. 2 is a diagram of overlapped spatial distributions of optical phase of an out-coupling grating structure and a phase compensation layer across a replicated pupil of the pupil-replicating lightguide of FIG. 1;

FIG. 3 is a diagram of overlapped spatial distributions of optical path length of an out-coupling grating structure and a phase compensation layer across a replicated pupil of the pupil-replicating lightguide of FIG. 1, illustrating an accuracy of optical phase planarization/path length equalization;

FIG. 4 is a magnified side cross-sectional view of a grating layer of the pupil-replicating lightguide of FIG. 1, showing a transition between non-grating and grating regions;

FIGS. 5A to 5D are side cross-sectional views of the pupil-replicating lightguide of FIG. 4 at different stages of manufacture;

FIG. 6 is a flow chart of a method of manufacturing of the pupil-replicating lightguide of FIG. 1 or FIG. 4;

FIG. 7 is a schematic view of a near-eye display of this disclosure, according to an embodiment;

FIG. 8 is a view of an augmented reality (AR) display of this disclosure having a form factor of a pair of eyeglasses; and

FIG. 9 is a three-dimensional view of a head-mounted display (HMD) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. In FIGS. 1, 4, 7, and 8, similar reference numerals denote similar elements.

A pupil-replicating lightguide of a near-eye visual display carries a beam of image light from a projector to an eye of a user. The beam of image light propagates in the pupil-replicating lightguide via multiple reflections from the lightguide's inner surfaces and multiple diffractions on in- and out-coupling grating structures of the lightguide. Each reflection or diffraction has a phase shift associated with that reflection or diffraction.

Lightguide's grating structures may be made non-uniform to provide a desired distribution of optical power density of out-coupled portions of the image light. Accordingly, an image light beam diffracted from non-uniform grating structures, and/or impinging on a boundary between a grating structure and a reflective surface free of any gratings, may have a phase profile with accumulated distortions. The distorted phase profile may cause a drop of modulation transfer function (MTF) of the pupil-replicating lightguide, especially at high spatial frequencies. The MTF degradation causes a loss of contrast, as well as blurriness of the image carried by the image light beam.

In accordance with this disclosure, a phase compensation layer may be added to a pupil-replicating lightguide's layer structure. The phase compensation layer has a pre-determined laterally variant optical thickness that offsets phase distortions caused by spatially non-uniform grating structures and interfaces, improving overall MTF and the associated image sharpness and contrast. In other words, the phase compensation layer “planarizes” the output phase of the image light, resulting in a higher overall quality of the displayed image.

In accordance with the present disclosure, there is provided a pupil-replicating lightguide comprising a slab of transparent material, an in-coupling grating structure coupled to the slab, an out-coupling grating structure coupled to the slab, and a phase compensation layer supported by at least one of the in-coupling grating structure, the out-coupling grating structure, or the slab. The in-coupling grating in-couples image light into the slab within an entrance pupil of the pupil-replicating lightguide, for propagating the image light in the slab by a series of internal reflections. The out-coupling grating structure replicates the entrance pupil by out-coupling a plurality of laterally offset portions of the image light from the slab, each out-coupled image light portion having a corresponding replicated pupil, the replicated pupils of the out-coupled image light portions forming an exit pupil of the pupil-replicating lightguide. The phase compensation layer has a laterally variant optical thickness for planarizing an optical phase profile of at least one image light portion across its corresponding replicated pupil. The pupil-replicating lightguide may further include an antireflection layer supported by the phase compensation layer.

The phase compensation layer may be configured for planarizing an optical phase profile of at least 10% or at least 30% of the out-coupled image light portions, and/or an optical phase profile of at least 10% or at least 30% of a total area of the exit pupil. The optical phase profile of the at least one image light portion may be flat to within π/5 for the image light at a wavelength of between 530 nm and 570 nm. The phase compensation layer may have a laterally variant physical thickness. An optical path of the at least one image light portion may include a boundary between an area of a surface of the slab free of grating structures and an area of the surface of the slab supporting the in-coupling or the out-coupling grating structure. The out-coupling grating structure may include first and second grating layers supported by opposite surfaces of the slab.

In some embodiments, the out-coupling grating structure and the phase compensation layer may form a stack supported by the slab. The out-coupling grating structure may include a grating layer, and the phase compensation layer may be supported by the grating layer. The phase compensation layer may be formed by inkjet coating.

In accordance with the present disclosure, there is provided a display apparatus comprising a projector for providing image light carrying an image in angular domain, the projector having an exit pupil, and a pupil-replicating lightguide described above. The optical phase profile of the at least one image light portion may be flat to within π/5 for a green color channel of the image light provided by the projector. The optical thickness of the phase compensation layer may be larger than one wavelength of a green color channel of the image light provided by the projector.

In accordance with the present disclosure, there is further provided a method of manufacturing a pupil-replicating lightguide. The method includes providing a slab of transparent material; forming an in-coupling grating structure on or in the slab for in-coupling image light into the slab within an entrance pupil of the pupil-replicating lightguide, for propagating the image light in the slab by a series of internal reflections; forming an out-coupling grating structure on or in the slab for replicating the entrance pupil by out-coupling a plurality of laterally offset portions of the image light from the slab, each out-coupled image light portion having a corresponding replicated pupil, the replicated pupils of the out-coupled image light portions forming an exit pupil of the pupil-replicating lightguide; and forming a phase compensation layer on at least one of the in-coupling grating structure, the out-coupling grating structure, or the slab, the phase compensation layer having a laterally variant optical thickness for planarizing an optical phase profile of at least one image light portion across its corresponding replicated pupil. Forming the out-coupling grating structure may include etching the slab. Forming the phase compensation layer may include inkjet coating at least one of the slab or the out-coupling grating structure at the laterally variant optical thickness.

Referring now to FIG. 1, a pupil-replicating lightguide 100 includes a substrate or slab 102 of a transparent material such as glass, plastic, metal oxide, crystal, etc. An in-coupling grating structure 104 is coupled to and supported by the slab 102. The in-coupling grating structure 104 may include e.g. surface-relief grating(s), volume grating(s), binary gratings, nanostructures, etc., and may be formed in the slab 102 in a layer deposited onto the slab 102, and so on. The purpose of the in-coupling grating structure 104 is to in-couple image light 106 into the slab 102 within an entrance pupil 108 of the pupil-replicating lightguide 100, for propagating the image light 106 in the slab 102 by a series of internal reflections, e.g. total internal reflections, forming a zigzag propagation path 106A. In FIG. 1, the propagation path 106A is illustrated with a solid arrowed zigzag line.

An out-coupling grating structure 110 is coupled to, and is supported by, the slab 102. The out-coupling grating structure 110 may include e.g. surface-relief grating(s), volume grating(s), binary gratings, nanostructures. The gratings/nanostructures may be formed on the slab 102, in the slab 102, in a layer deposited onto the slab 102, etc. The purpose of the out-coupling grating structure 110 is to replicate the entrance pupil 108 by out-coupling a plurality of laterally offset portions 112 of the image light 106 from the slab 102. Dashed arrows 112A denote a propagation path of the respective out-coupled portions 112 of the image light 106. Each out-coupled image light portion 112 has a corresponding replicated pupil 114. The replicated pupils 114 of the out-coupled image light portions 112 may overlap as shown to form an exit pupil 116 of the pupil-replicating lightguide 100.

The out-coupling grating structure 110 may have spatially non-uniform optical properties such as thickness, refractive index, duty cycle, etc. The optical properties are spatially varying in a pre-determined manner along the propagation path 106A of the image light 106, and more generally varying laterally, i.e. in XY plane. The spatially non-uniform optical properties may cause the optical phase across the replicated pupils 114 of diffracted image light portions 112 to be spatially variant. The spatially variant optical phase is undesirable since it worsens a modulation transfer function (MTF) of the pupil-replicating lightguide 100, causing the image being conveyed by the pupil-replicating lightguide 100 to be blurred and/or have a reduced contrast of small features of the image.

In some embodiments, the diffracted image light portions 112 are not coherent w.r.t. each other, such that the optical phase distributions across different replicated pupils 114 are not correlated to one another. In such embodiments, the images carried by each diffracted image light portion 112 are added incoherently at the user's eye pupil. In other embodiments, the diffracted image light portions 112 are coherent, and the output image is formed by a coherent addition of the wavefronts of different replicated pupils 114. To improve the MTF for either or both incoherent and coherent pupil replication embodiments, a phase compensation layer 118 may be provided. The phase compensation layer 118 may be supported by in-coupling grating structure 104, the out-coupling grating structure 110, and/or the slab 102 itself. By way of a non-limiting example, the phase compensation layer 118 may form a stack with a grating layer of the out-coupling grating structure 110, the layer stack being supported by the slab 102.

The phase compensation layer 118 may have a laterally variant thickness and/or refractive index for planarizing an optical phase profile of each image light portion 112 across its corresponding replicated pupil 114. Herein, the term “laterally variant” means varying in XY plane, i.e. dependent on X- and/or Y-coordinates in a plane parallel to the slab 102 and the layers it supports. More generally, the phase compensation layer 118 may have a laterally variant or spatially varying optical thickness. The optical thickness is defined as a local (i.e. at each XY point) physical or geometrical thickness multiplied by the local refractive index. The optical thickness may vary in XY plane, i.e. along the propagation path 106A (Y-axis) and/or in a perpendicular direction, i.e. along X-axis in FIG. 1. The phase compensation layer 118 may be disposed on a same surface as the in-coupling 104 and/or out-coupling 110 grating structure, on the opposed surface, inside the slab 102, or on both sides or at multiple locations in some embodiments.

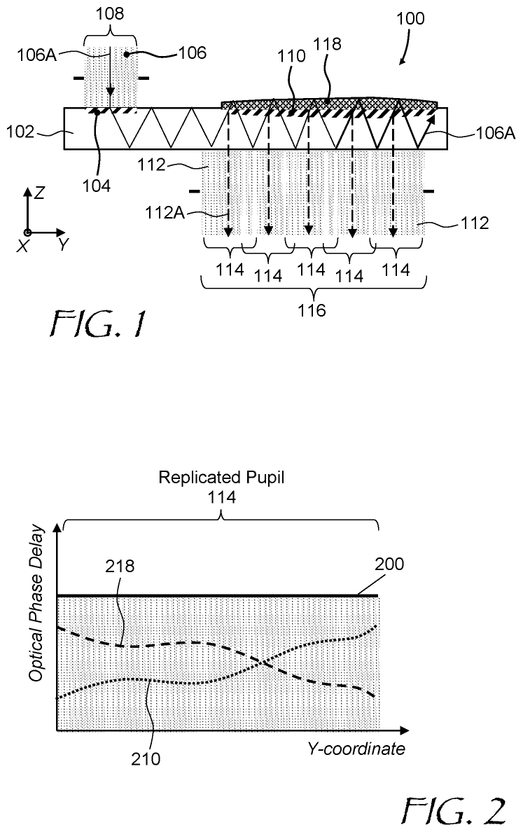

The planarization/flattening/evening out of the optical phase profile across at least one replicated pupil 114 is illustrated in FIG. 2, where a lateral distribution of optical phase delay 210 (dotted line) added by the out-coupling grating structure 110 to the image light 106 is superimposed with a lateral distribution of optical phase delay 218 (dashed line) added by the phase compensation layer 118 to the image light 106. The two lateral distributions of optical phase delay 210, 218 mirror each other, adding up to a substantially flat overall phase distribution 200 shown with a thick solid line. In other words, the overall phase delay including the delay by the out-coupling grating structure 110 and the phase compensation layer 118 is flattened, i.e. substantially does not depend on X, Y coordinates.

The planarization of optical phase delay distribution allows the optical phase profile of at least one image light portion 112 across its corresponding replicated pupil 116 to be flattened or “planarized”. In some embodiments, the phase compensation layer 118 is configured to planarize an optical phase of at least 10% of the out-coupled image light portions, or at least 30% or, for best performance, all of the image light portions 112 out-coupled by the out-coupling grating structure 110. For coherent embodiments of the pupil-replicating lightguide 100, such planarization will result in the flat optical phase profile for the entire exit pupil 116. Herein, the term “flatten” or “planarize”, when applied to an optical phase profile, is taken to mean as to make flat to within π/5 for a green color channel of the image light. For definiteness, the green color channel wavelengths may be defined as wavelengths of between 530 nm and 570 nm. In some embodiments including both coherent and non-coherent embodiments of the pupil-replicating lightguide 100, the phase compensation layer 118 may be configured for planarizing an optical phase profile of at least 10%, or at least 30% of a total area of the exit pupil 116.

The planarization of the optical phase distribution illustrated in FIG. 2 may be achieved by laterally varying the geometrical thickness (i.e. the physical thickness) of the phase compensation layer 118 at a constant refractive index, the laterally varying the refractive index at the constant geometrical thickness, or laterally varying both the geometrical (physical) thickness and the refractive index. It is noted that the optical thickness of the phase compensation layer 118 may be greater than an integer number of wavelengths for convenience of manufacturing using suitable methods such as inkjet printing—a method considered further below.

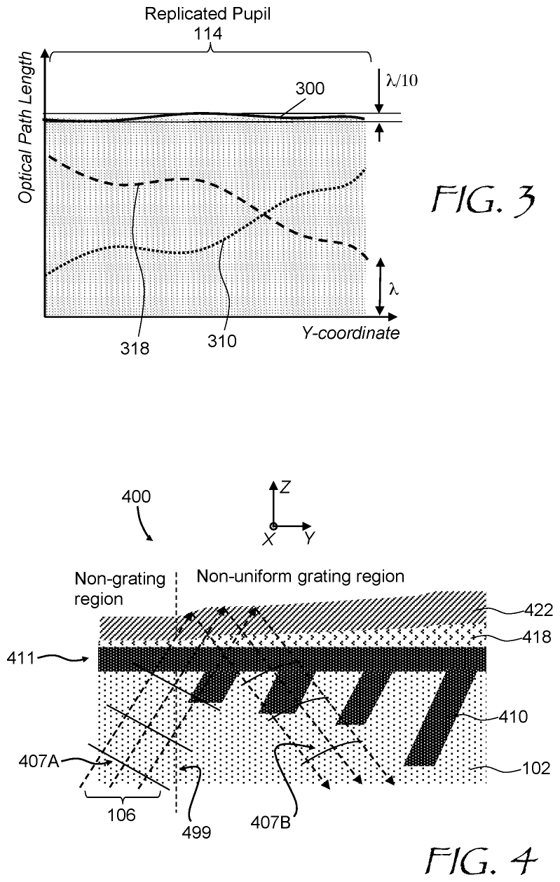

An optical thickness lateral distribution of the phase compensation layer 118 is illustrated in FIG. 3, which shows a lateral distribution of the optical path length 310 (dotted line) added by the out-coupling grating structure 110 superimposed with a lateral distribution of the optical path length 318 (dashed line) added by the phase compensation layer 118. An optical path length is defined herein as an integral along the optical path of geometrical path length multiplied by a local refractive index.

The overall path length, which is a sum of the out-coupling grating structure 110 optical path length 310 and the phase compensation layer 118 optical path length lateral distribution 318, is illustrated by a solid line 300. The overall optical path length shows some residual dependence on a lateral coordinate (i.e. Y-coordinate in this case). For best MTF performance, the overall path length may vary by no greater than one tenth of the wavelength of the green color channel, or no greater than π/5 in optical phase units. It is further noted that the optical thickness or optical path length of the phase compensation layer does not need to be less than one wavelength; for example in FIG. 3, the optical thickness is larger than one wavelength 2 of a green color channel of the image.

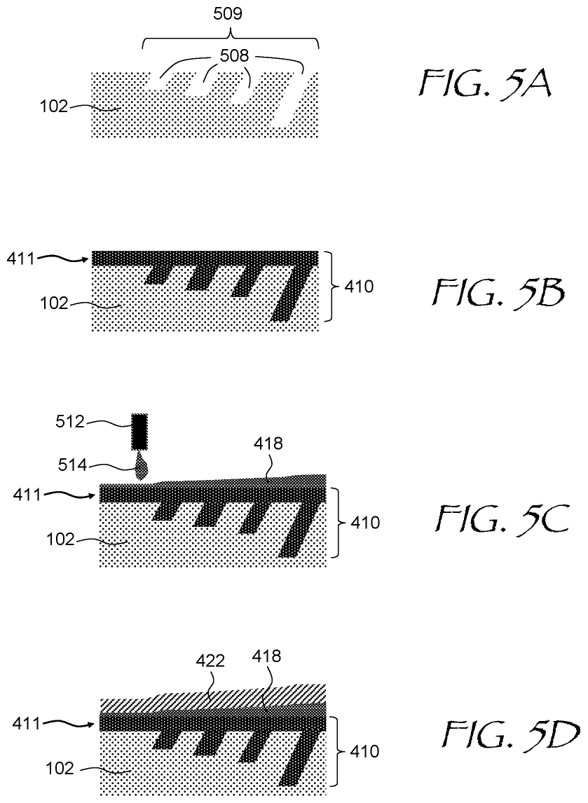

Referring now to FIG. 4, a pupil-replicating lightguide 400 is an embodiment of the pupil-replicating lightguide 100 of FIG. 1. The pupil-replicating lightguide 400 of FIG. 4 includes an out-coupling grating 410 formed by etching the slab 102 and spin-coating a grating layer 411 onto the etched slab 102. A phase compensation layer 418 may be deposited upon and supported by the grating layer 411. The phase compensation layer 418 may be formed by inkjet coating, as explained further below with reference to FIG. 5. An antireflection layer 422 (FIG. 4) may be deposited upon, and supported by the phase compensation layer 418. The out-coupling grating 410 is non-uniform along Y-axis in this example, i.e. the grating thickness and strength (i.e. the diffraction efficiency) of the out-coupling grating 410 increases in Y-direction.

In operation, the image light 106 propagating inside the slab 102 impinges onto the out-coupling grating 410. A portion of the image light (not shown for brevity) is diffracted out of the slab 102, while the remaining portion propagates through the phase compensation layer 418 and is internally reflected from the antireflection layer 422, propagating again through the phase compensation layer 418 and the out-coupling grating 410. A flat wavefront 407A of the image light 106 may be somewhat perturbed upon propagation as indicated with a non-flat wavefront 407B. The perturbation may result from the optical path of the image light portion including a boundary 499 between an area of a surface of the slab free of grating structures (left of the boundary 499 in FIG. 4) and an area of the surface of the slab supporting a grating structure (right of the boundary 499), e.g. an in-coupling or an out-coupling grating. For example, in FIG. 4, the slab 102 supports the out-coupling grating 410. The function of the phase compensation layer 418 is to reduce or completely eliminate such perturbation regardless of its origin, thereby improving the MTF of the pupil-replicating lightguide 400 across at least one replicated pupil, and improving overall displayed image quality.

Turning to FIGS. 5A to 5D with further reference to FIG. 4, the pupil-replicating lightguide 400 of FIG. 4 may be manufactured by directional etching or nanoimprinting a grating structure 509 in the slab 102 (FIG. 5A). The directional etching may be performed by non-plasma-based etching methods such as e.g. wet chemistries, atomic layer etch, crystal facet etch, etc., or by plasma-based etching such as, without limitation, physical or chemical etching. The directional etching results in forming slanted channels 508 in the slab 102. The channels 508 have a laterally varying depth, e.g. in FIG. 5A, the channel depth increases in going from left to right. The grating layer 411 may be spin-coated onto the etched surface of the slab 102, filling the slanted channels 508 with the grating layer material and forming the out-coupling grating 410 (FIG. 5B). The spin-coating material may include e.g. silicon nitride, titanium dioxide, organics, inorganics, metal organics, nanoparticles, etc.

The phase compensation layer 418 may be inkjet coated onto the grating layer 411 (FIG. 5C). To that end, a dispensing nozzle 512 may be translated across the slab 102 along one or two perpendicular axes parallel to the top surface of the slab 102, e.g. in a rectangular or rastering pattern, to coat the grating layer 411 to a controllable spatially variable thickness with phase compensating material 514 to form the phase compensation layer 418 having a pre-determined optical thickness distribution. The phase compensating layer 418 may include such material(s) as silicon nitride, titanium dioxide, silicon dioxide, silicon monoxide, organics, inorganics, metal organics, nanoparticle, etc. The deposited material may be cured by ultraviolet light. Finally, the antireflection layer 422 may be coated, e.g. spin-coated or deposited using physical or chemical vapor deposition methods, onto the phase compensation layer 418 (FIG. 5D).

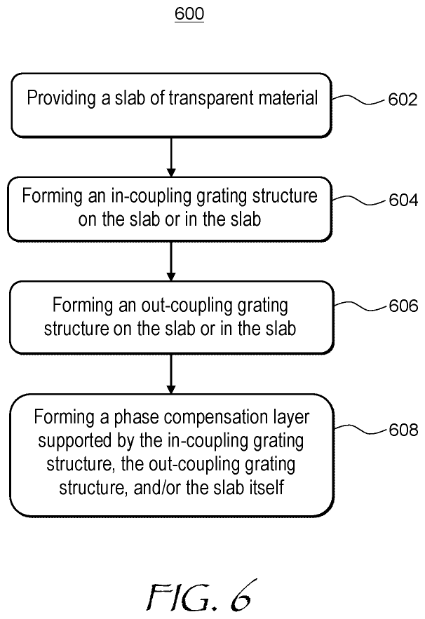

A flow chart of a method of manufacturing a pupil-replicating lightguide such as the pupil-replicating lightguide 100 of FIG. 1 or the pupil-replicating lightguide 400 of FIG. 4 is further illustrated in FIG. 6. A slab of transparent material, e.g. glass, plastic, transparent oxide, crystal, etc., is provided (602) for processing. The slab of step 602 of FIG. 6 corresponds to the slab 102 of FIGS. 1 and 4. The slab 102 may be plano-parallel or curved.

An in-coupling grating structure is formed (604) on the slab 102, or in the slab 102. The in-coupling grating structure (e.g. the in-coupling grating structure 104 of FIG. 1) is configured for in-coupling image light, e.g. the image light 106 (FIGS. 1 and 4) into the slab 102 within the entrance pupil 108 of the pupil-replicating lightguide, for propagating in the slab by a series of internal reflections from opposed surfaces of the slab 102, as best seen in FIG. 1. Configuring the in-coupling grating structure may include, for example, selecting the grating material, selecting fringe pitch and slant angle, selecting the length, width, and location of the grating structures, etc.

An out-coupling grating structure may be formed (606) on the slab 102 or in the slab 102. An example process for forming the out-coupling grating structure 411 of FIG. 4 has been described above with reference to FIGS. 5A-5D as one implementation of this method step, i.e. including etching and backfilling the slanted channels 508 as shown in FIGS. 5A-5D. The manufactured out-coupling grating structure may be configured for replicating the entrance pupil by out-coupling a plurality of laterally offset portions 112 of the image light from the slab 102 (FIG. 1), each out-coupled image light portion having the corresponding replicated pupil 114, the replicated pupils 114 of the out-coupled image light portions 112 forming the exit pupil 116 of the pupil-replicating lightguide.

A phase compensation layer may be formed (608) on at least one of the in-coupling grating structure, the out-coupling grating structure, or the slab itself. For example, the phase compensation layer 418 may be formed on the grating layer 411 by inkjet printing (FIG. 5C). The phase compensation layer 418 has a spatially varying optical thickness, i.e. spatially varying physical thickness, spatially varying refractive index, or both, for planarizing an optical phase profile of at least one image light portion across its replicated pupil. In some embodiments, at least 10% of the image light portions, at least 30%, or all of the image light portions may have the planarized optical phase profile, as explained above.

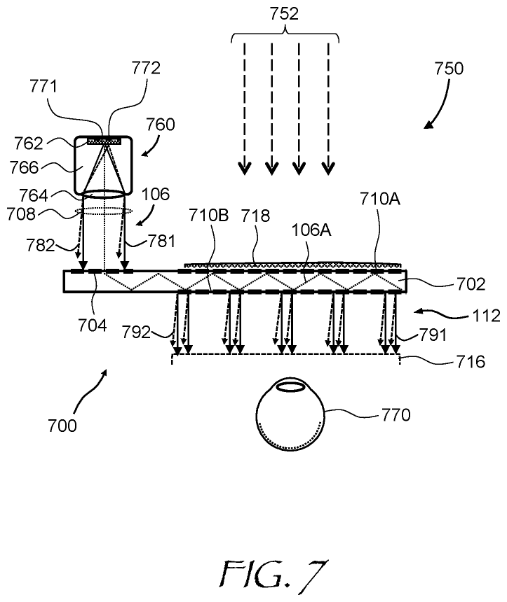

Referring to FIG. 7, a display apparatus 750 includes a projector 760 optically coupled to a pupil-replicating lightguide 700. The projector 760 includes a miniature display panel 762 and a collimator 764, e.g. a lens, optically coupled to the display panel 762. The display panel 762 and the collimator 764 are supported in a fixed-apart relationship by a body 766 to provide the image light 106, which carries an image in angular domain across an exit pupil 708. Herein, the term “image in angular domain” means an image where different elements of an image in linear or spatial domain, i.e. pixels of the image displayed by a display panel, are represented by angles of corresponding rays of image light, the rays carrying optical power levels and/or color composition corresponding to brightness and/or color values of the image pixels. For example, a first pixel 771 of the display panel 762 disposed at the center of the display panel 762 emits light that is collimated by the collimator 764 into a straight collimated light beam 781 shown with solid lines. A second pixel 772 of the display panel 762 disposed off center of the display panel 762 emits light that is collimated by the collimator 764 into a skewed collimated light beam 782 shown with dashed lines. Other types of the projector 760, e.g. a scanning beam projector including a tiltable reflector, may be used.

The pupil-replicating lightguide 700 is an embodiment of the pupil-replicating lightguide 100 of FIG. 1 or the pupil-replicating lightguide 400 of FIG. 4. The pupil-replicating lightguide 700 includes a slab 702 of a transparent material such as glass, plastic, a transparent oxide, a crystal, etc. An in-coupling grating structure 704 is supported by the slab 702 for in-coupling the image light 106 into the slab 702 for propagation in the slab 702 by a series of internal reflections, as indicated by the propagation path 106A of the image light 106 (dotted lines in FIG. 7). An out-coupling grating structure includes a top grating 710A and, optionally, a bottom grating 710B supported by opposite surfaces of the slab 702 for replicating the projector's 760 exit pupil 708 by out-coupling the plurality of laterally offset portions 112 of the image light 106 from the slab 702. Each out-coupled image light portion 112 has a corresponding replicated pupil. The replicated pupils of the out-coupled image light portions 112 combine together to form an exit pupil 716 of the pupil-replicating lightguide 700. The replicated pupils of the out-coupled image light portions 112 may overlap with one another. The grating parameters of the in-coupling grating 704 and the top 710A and bottom 710B out-coupling gratings are selected so as to preserve the angular distribution of the image light 106, thereby conveying the image in angular domain carried by the image light 106 across the entire exit pupil 716 for observation by a user's eye 770. Continuing the example with the first 771 and second 772 pixels and their emitted straight 781 and skewed 782 collimated image light beams, the straight collimated beam 781 is split into a plurality of straight output collimated sub-beams 791, and the skewed collimated light beam 782 is split into a plurality of skewed output collimated sub-beams 792.

The pupil-replicating lightguide 700 further includes a phase compensation layer 718, which is similar to the phase compensation layer 118 of the pupil-replicating lightguide 100 of FIG. 1, the phase compensation layer 418 of the pupil-replicating lightguide 400 of FIG. 4, and operates in a similar manner. The phase compensation layer 718 has a spatially varying optical thickness for planarizing an optical phase profile of at least one image light portion or sub-beam across its corresponding replicated pupil. In some embodiments, the phase profile of at least 10,%, 30%, or the whole 100% of the one image light portions or sub-beams is flattened or planarized, e.g. to within π/5 for a green color channel of the image light provided by the projector 760. It is to be noted that the optical phase profile of each image light portion may be impacted by both the top 710A and bottom 710B out-coupling gratings in this example. The entire optical stack of the pupil-replicating lightguide 700 may be transparent to outside light 752 in visible portion of the optical spectrum, enabling the user of the display apparatus 750 to see the outside world superimposed with artificial imagery generated by the projector 760.

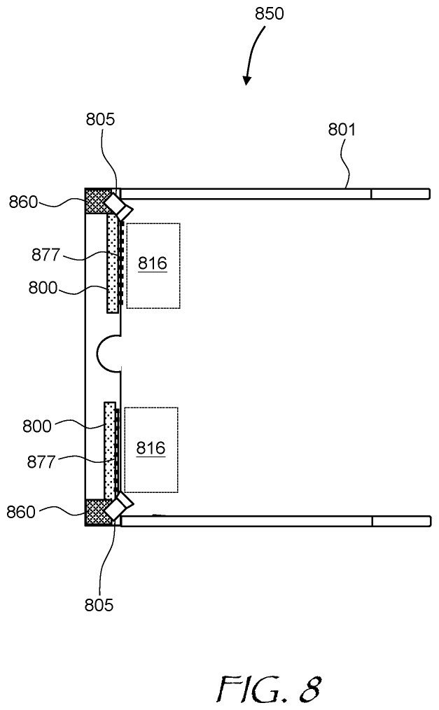

Turning to FIG. 8, an augmented reality (AR) near-eye display 850 includes a frame 801 having a form factor of a pair of eyeglasses. The frame 801 supports, for each eye: a projector 860, a pupil-replicating waveguide 800 such as the pupil-replicating waveguide 100 of FIG. 1, the pupil-replicating waveguide 400 of FIG. 4, or the pupil-replicating waveguide 700 of FIG. 7 etc., optically coupled to the projector 860, an eye-tracking camera 805, a and a plurality of illuminators 877. The illuminators 877 may be supported by the pupil-replicating waveguide 800 for illuminating an eyebox 816 defined as an area where an image of acceptable quality may be observed by a user's eye, not shown.

The projector 860 provides a fan of light beams carrying an image in angular domain to be viewed by a user's eye placed in the eyebox 816. The pupil-replicating waveguide 800 receives the fan of light beams and provides multiple laterally offset parallel copies of each beam of the fan of light beams, thereby extending the projected image over the entire eyebox 816. Multi-emitter laser sources may be used in the projector 860. Each emitter of the multi-emitter laser chip may be configured to emit image light at an emission wavelength of a same color channel. The emission wavelengths of different emitters of the same multi-emitter laser chip may occupy a spectral band having the spectral width of the laser source.

In some embodiments, the projector 860 may include two or more multi-emitter laser chips emitting light at wavelengths of a same color channel or different color channels. For augmented reality (AR) applications, the pupil-replicating waveguide 800 can be transparent or translucent to enable the user to view the outside world together with the images projected into each eye and superimposed with the outside world view. The images projected into each eye may include objects disposed with a simulated parallax, so as to appear immersed into the real world view.

The purpose of the eye-tracking cameras 805 is to determine position and/or orientation of both eyes of the user. Once the position and orientation of the user's eyes are known, a gaze convergence distance and direction may be determined. The imagery displayed by the projectors 860 may be dynamically adjusted to account for the user's gaze for a better fidelity of immersion of the user into the displayed augmented reality scenery, and/or to provide specific functions of interaction with the augmented reality that may not ne found in the real world.

In operation, the illuminators 877 illuminate the eyes at the corresponding eyeboxes 816, to enable the eye-tracking cameras 805 to obtain the images of the eyes, as well as to provide reference reflections i.e. glints. The glints may function as reference points in the captured eye images, facilitating the eye gazing direction determination by determining position of the eye pupil images relative to the glints images. To avoid distracting the user with illuminating light, the latter may be made invisible to the user. For example, infrared light may be used to illuminate the eyeboxes 816.

Images obtained by the eye-tracking cameras 805 may be processed in real time to determine the eye gazing directions of both eyes of the user. In some embodiments, the image processing and eye position/orientation determination functions may be performed by a central controller, not shown, of the AR near-eye display 850. The central controller may also provide control signals to the projectors 805 to generate the images to be displayed to the user, depending on the determined eye positions, eye orientations, gaze directions, eyes vergence, etc.

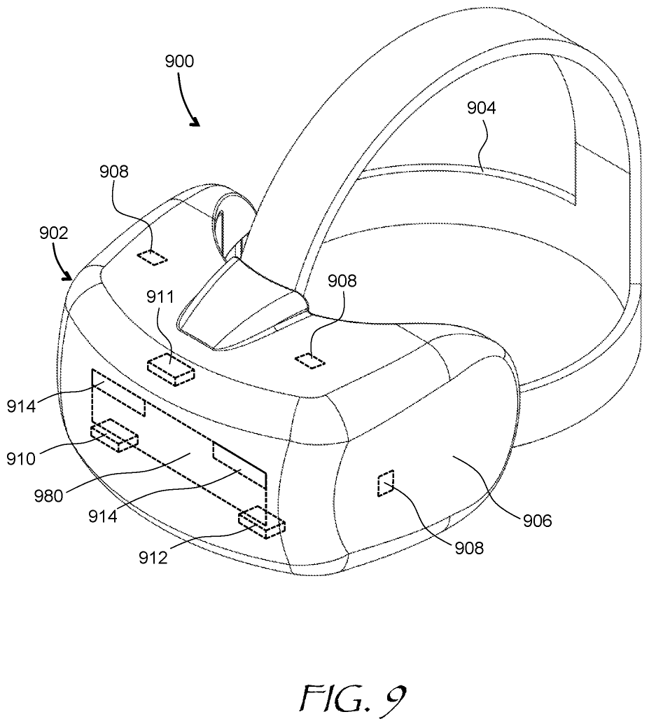

Turning to FIG. 9, an HMD 900 is an example of an AR/VR wearable display system which encloses the user's face, for a greater degree of immersion into the AR/VR environment. The HMD 900 may generate the entirely virtual 3D imagery. The HMD 900 may include a front body 902 and a band 904 that can be secured around the user's head. The front body 902 is configured for placement in front of eyes of a user in a reliable and comfortable manner. A display system 980 may be disposed in the front body 902 for presenting AR/VR imagery to the user. The display system 980 may include any of the displays and pupil-replicating lightguides disclosed herein. Sides 906 of the front body 902 may be opaque or transparent.

In some embodiments, the front body 902 includes locators 908 and an inertial measurement unit (IMU) 910 for tracking acceleration of the HMD 900, and position sensors 912 for tracking position of the HMD 900. The IMU 910 is an electronic device that generates data indicating a position of the HMD 900 based on measurement signals received from one or more of position sensors 912, which generate one or more measurement signals in response to motion of the HMD 900. Examples of position sensors 912 include: one or more accelerometers, one or more gyroscopes, one or more magnetometers, another suitable type of sensor that detects motion, a type of sensor used for error correction of the IMU 910, or some combination thereof. The position sensors 912 may be located external to the IMU 910, internal to the IMU 910, or some combination thereof.

The locators 908 are traced by an external imaging device of a virtual reality system, such that the virtual reality system can track the location and orientation of the entire HMD 900. Information generated by the IMU 910 and the position sensors 912 may be compared with the position and orientation obtained by tracking the locators 908, for improved tracking accuracy of position and orientation of the HMD 900. Accurate position and orientation is important for presenting appropriate virtual scenery to the user as the latter moves and turns in 3D space.

The HMD 900 may further include a depth camera assembly (DCA) 911, which captures data describing depth information of a local area surrounding some or all of the HMD 900. The depth information may be compared with the information from the IMU 910, for better accuracy of determination of position and orientation of the HMD 900 in 3D space.

The HMD 900 may further include an eye tracking system 914 for determining orientation and position of user's eyes in real time. The obtained position and orientation of the eyes also allows the HMD 900 to determine the gaze direction of the user and to adjust the image generated by the display system 980 accordingly. The determined gaze direction and vergence angle may be used to adjust the display system 980 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 902.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A pupil-replicating lightguide comprising:
a slab of transparent material;
an in-coupling grating structure coupled to the slab for in-coupling image light into the slab within an entrance pupil of the pupil-replicating lightguide, for propagating the image light in the slab by a series of internal reflections;
an out-coupling grating structure coupled to the slab for replicating the entrance pupil by out-coupling a plurality of laterally offset portions of the image light from the slab, each out-coupled image light portion having a corresponding replicated pupil, the replicated pupils of the out-coupled image light portions forming an exit pupil of the pupil-replicating lightguide; and
a phase compensation layer supported by at least one of the in-coupling grating structure, the out-coupling grating structure, or the slab, the phase compensation layer having a laterally variant optical thickness for planarizing an optical phase profile of at least one image light portion across its corresponding replicated pupil.

2. The pupil-replicating lightguide of claim 1, wherein the phase compensation layer is configured for planarizing an optical phase profile of at least 10% of the out-coupled image light portions.

3. The pupil-replicating lightguide of claim 1, wherein the phase compensation layer is configured for planarizing an optical phase profile of at least 10% of a total area of the exit pupil.

4. The pupil-replicating lightguide of claim 1, wherein the optical phase profile of the at least one image light portion is flat to within π/5 for the image light at a wavelength of between 530 nm and 570 nm.

5. The pupil-replicating lightguide of claim 1, wherein the phase compensation layer has a laterally variant physical thickness.

6. The pupil-replicating lightguide of claim 1, wherein an optical path of the at least one image light portion includes a boundary between an area of a surface of the slab free of grating structures and an area of the surface of the slab supporting the in-coupling or the out-coupling grating structure.

7. The pupil-replicating lightguide of claim 1, wherein the out-coupling grating structure comprises first and second grating layers supported by opposite surfaces of the slab.

8. The pupil-replicating lightguide of claim 1, wherein the out-coupling grating structure and the phase compensation layer form a stack supported by the slab.

9. The pupil-replicating lightguide of claim 8, wherein the out-coupling grating structure comprises a grating layer, wherein the phase compensation layer is supported by the grating layer.

10. The pupil-replicating lightguide of claim 1, wherein the phase compensation layer is formed by inkjet coating.

11. The pupil-replicating lightguide of claim 10, further comprising an antireflection layer supported by the phase compensation layer.

12. A display apparatus comprising:
a projector for providing image light carrying an image in angular domain, the projector having an exit pupil; and
a pupil-replicating lightguide comprising:
a slab of transparent material;
an in-coupling grating structure coupled to the slab for in-coupling the image light into the slab for propagation in the slab by a series of internal reflections;
an out-coupling grating structure coupled to the slab for replicating the projector's exit pupil by out-coupling a plurality of laterally offset portions of the image light from the slab, each out-coupled image light portion having a corresponding replicated pupil, the replicated pupils of the out-coupled image light portions forming an exit pupil of the pupil-replicating lightguide; and
a phase compensation layer having a laterally variant optical thickness for planarizing an optical phase profile of at least one image light portion across its corresponding replicated pupil.

13. The display apparatus of claim 12, wherein the phase compensation layer is configured for planarizing an optical phase profile of at least 30% of the out-coupled image light portions.

14. The display apparatus of claim 12, wherein the optical phase profile of the at least one image light portion is flat to within π/5 for a green color channel of the image light provided by the projector.

15. The display apparatus of claim 12, wherein an optical path of the at least one image light portion includes a boundary between an area of a surface of a slab free of grating structures and an area of the surface of the slab supporting the in-coupling or the out-coupling grating structure.

16. The display apparatus of claim 12, wherein at least at one location, the optical thickness of the phase compensation layer is larger than one wavelength of a green color channel of the image light provided by the projector.

17. The display apparatus of claim 12, wherein the out-coupling grating structure and the phase compensation layer form a layer stack supported by the slab.

18. A method of manufacturing a pupil-replicating lightguide, the method comprising:
providing a slab of transparent material;
forming an in-coupling grating structure on or in the slab for in-coupling image light into the slab within an entrance pupil of the pupil-replicating lightguide, for propagating the image light in the slab by a series of internal reflections;
forming an out-coupling grating structure on or in the slab for replicating the entrance pupil by out-coupling a plurality of laterally offset portions of the image light from the slab, each out-coupled image light portion having a corresponding replicated pupil, the replicated pupils of the out-coupled image light portions forming an exit pupil of the pupil-replicating lightguide; and
forming a phase compensation layer on at least one of the in-coupling grating structure, the out-coupling grating structure, or the slab, the phase compensation layer having a laterally variant optical thickness for planarizing an optical phase profile of at least one image light portion across its corresponding replicated pupil.

19. The method of claim 18, wherein forming the out-coupling grating structure comprises etching the slab.

20. The method of claim 18, wherein forming the phase compensation layer comprises inkjet coating at least one of the slab or the out-coupling grating structure at the laterally variant optical thickness.
